(19) United States
(12) Patent Application Publication
(10) Pub. No.: US 2024/0002157 A1
(43) Pub. Date: Jan. 4, 2024

(54) BELT UNIT AND IMAGE FORMING APPARATUS

(71) Applicant: FUJIFILM Business Innovation Corp., Tokyo (JP)

(72) Inventors: Toshihiko KAMIYAMA, Kanagawa (JP); Kaoru MATSUSHITA, Kanagawa (JP)

(73) Assignee: FUJIFILM Business Innovation Corp., Tokyo (JP)

(21) Appl. No.: 18/181,088

(22) Filed: Mar. 9, 2023

(30) Foreign Application Priority Data
Jul. 4, 2022 (JP) 2022-107741

(51) Int. Cl. B65G 15/60; B65G 39/16; G03G 15/00

(52) U.S. Cl. CPC B65G 15/60; G03G 2215/00139; G03G 15/6529; B65G 39/16

(57) ABSTRACT

A belt unit includes a belt member to be caused to rotate, a stretching member that is rotatable about an axis and over which the belt member is stretched, and a rotatable member that is rotatable about the axis and relative to the stretching member and over which the belt member is stretched, the rotatable member including a receiving part configured to receive the belt member in an axial direction when the belt member is shifted in the axial direction.

### CROSS-REFERENCE TO RELATED APPLICATIONS

This application is based on and claims priority under 35 USC 119 from Japanese Patent Application No. 2022-107741 filed Jul. 4, 2022.

### BACKGROUND

### (i) Technical Field

The present disclosure relates to a belt unit and an image forming apparatus.

### (ii) Related Art

Japanese Unexamined Patent Application Publication No. 2009-265421, for example, relates to a belt unit including an endless transporting belt, a driving roller over which the transporting belt is stretched and to which a driving force is supplied to rotate the transporting belt, and a follower roller over which the transporting belt is also stretched. The follower roller includes three rollers that are separate from one another in the axial direction and are rotatable independently of one another, and flanges configured to rotate together with two of the rollers that are located at two respective axial ends of the follower roller, the flanges each receiving a corresponding one of the edges of the transporting belt that comes into contact therewith. The belt unit further includes friction plates located at the two respective axial ends of the follower roller and that each apply a frictional force to a corresponding one of the flanges when the flange is moved in the axial direction by receiving the edge of the transporting belt and comes into contact with the friction plate. Japanese Unexamined Patent Application Publication No. 2012-63655 relates to a configuration in which a tension roller includes a plurality of rollers that are separate from one another in the axial direction and are rotatable independently of one another.

### SUMMARY

In such a related art, if the belt member stretched over the stretching member is shifted in the width direction by a large amount while the belt member is rotating, the belt member may ride on a portion of the stretching member that is not supposed to come into contact with the belt member while the belt member is rotating, leading to a damage to the belt member.

Aspects of non-limiting embodiments of the present disclosure relate to maintaining the state of contact between the stretching member and the belt member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a belt unit including a belt member to be caused to rotate, a stretching member that is rotatable about an axis and over which the belt member is stretched, and a rotatable member that is rotatable about the axis and relative to the stretching member and over which the belt member is stretched, the rotatable member including a receiving part configured to receive the belt member in an axial direction when the belt member is shifted in the axial direction.

### BRIEF DESCRIPTION OF THE DRAWINGS

An exemplary embodiment of the present disclosure will be described in detail based on the following figures, wherein:

FIG. 1 is a front view of an image forming apparatus and illustrates the overall configuration thereof;

FIG. 2 schematically illustrates relevant elements of a transfer-transporting belt unit according to an exemplary embodiment;

FIG. 3 illustrates a situation where a transporting belt has been shifted in the axial direction;

FIG. 4A illustrates an end portion of the transporting belt that is to be received by a receiving part of a corresponding one of pulleys, with a contact part of the pulley being spaced apart from a corresponding one of washers;

FIG. 4B illustrates the end portion of the transporting belt that is to be received by the receiving part of the pulley, with the contact part being in contact with the washer;

FIGS. 5A and 5B are block diagrams illustrating how the transporting belt and a set of a pressing roll and the pulleys interact with each other;

FIG. 6 illustrates how the transporting belt behaves;

FIG. 7A schematically illustrates relevant elements of a transfer-transporting belt unit according to a modification, with a contact part of a pulley thereof being spaced apart from a fixed holding member; and

FIG. 7B schematically illustrates the elements, with the contact part being in contact with the fixed holding member.

### DETAILED DESCRIPTION

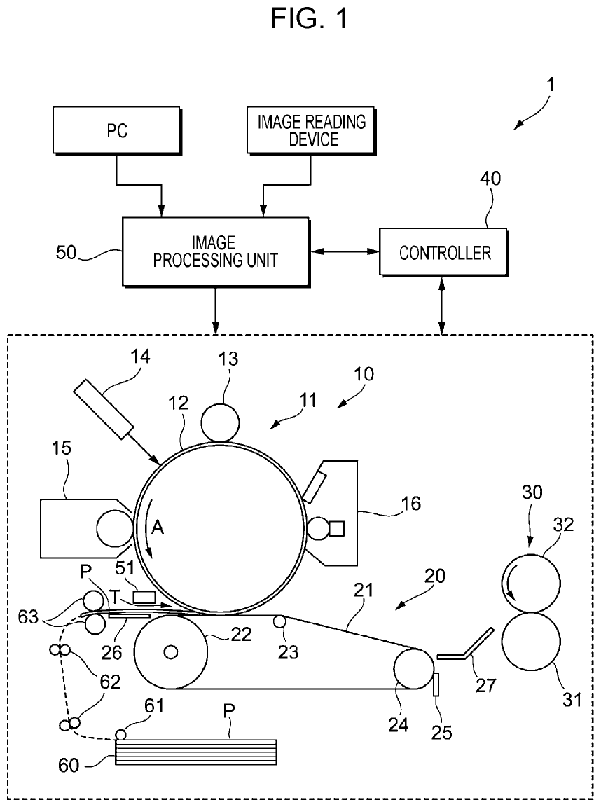

FIG. 1 is a front view of an image forming apparatus 1 and illustrates the overall configuration thereof.

The image forming apparatus 1 includes an image forming section 10, which is configured to form an image on a sheet P, serving as an exemplary recording material, with reference to image data.

The image forming section 10 includes an image forming unit 11, which is configured to form a toner image (an image) in black (K). The image forming unit 11 includes a photoconductor drum 12; a charging device 13, which is configured to charge the photoconductor drum 12; and a laser exposure device 14, which is configured to expose the photoconductor drum 12 to light.

The photoconductor drum 12 is charged by the charging device 13. Then, the photoconductor drum 12 is exposed to light by the laser exposure device 14, whereby an electrostatic latent image is formed on the photoconductor drum 12.

The image forming unit 11 further includes a developing device 15, which is configured to develop the electrostatic latent image formed on the photoconductor drum 12; and a cleaner 16, which is configured to clean the surface of the photoconductor drum 12 after a transfer process.

The image forming section 10 further includes a transfer-transporting belt unit 20, which is configured to transfer the black toner image formed on the photoconductor drum 12 to a sheet P and transport the sheet P; and a fixing device 30, which is configured to fix the toner image transferred to the sheet P.

The transfer-transporting belt unit 20 includes a transporting belt 21, with which the sheet P is to be transported from a transfer part T toward the fixing device 30; a transfer roll 22, which is located at an upstream position of the transporting belt 21 in the direction of sheet transport and across from the photoconductor drum 12 and to which a transfer voltage is to be applied; and a pressing roll 23, which presses the transporting belt 21 against the photoconductor drum 12. The transfer roll 22 has a crown shape and includes a foamed rubber layer.

The transfer-transporting belt unit 20 further includes a release roll 24, which is located at a downstream position of the transporting belt 21 in the direction of sheet transport where the sheet P is to be released from the transporting belt 21; and a blade 25, with which the surface of the transporting belt 21 is cleaned after the sheet P is released therefrom.

A transport guide 26 is provided on the upstream side relative to the transfer-transporting belt unit 20 in the direction of sheet transport and guides the sheet P to the transfer part T. A chute 27 is provided between the transporting belt 21 and the fixing device 30 and guides the sheet P received from the transporting belt 21 to the fixing device 30.

While the present exemplary embodiment relates to a case where the transfer-transporting belt unit 20 is configured to be driven by receiving a driving force generated by a motor that drives the photoconductor drum 12, another embodiment may be employed in which the transfer-transporting belt unit 20 is configured to be driven with a driving force generated by a motor different from the motor for the photoconductor drum 12.

The transfer-transporting belt unit 20 is an exemplary belt unit, the transporting belt 21 is an exemplary belt member, and the pressing roll 23 is an exemplary stretching member.

The fixing device 30 includes a pressing roll 31 and a fixing roll 32. The pressing roll 31 is pressed against the fixing roll 32 and thus forms a nip where the sheet P is to be pressed when passing therethrough.

The pressing roll 31 includes a core, an elastic layer that covers the core, a releasing layer that covers the elastic layer, and a heat source provided in a central part of the core. The fixing roll 32 includes a core, an elastic layer that covers the core, a releasing layer that covers the elastic layer, and a heat source provided in a central part of the core.

The image forming apparatus 1 includes a controller 40, which is configured to control functional units provided in the image forming apparatus 1; and an image processing unit 50, which is configured to process image data received from a device such as a personal computer (PC) or an image reading device. The controller 40 and the image processing unit 50 are each formed of an application-specific integrated circuit (ASIC). The controller 40 and the image processing unit 50 may each be realized as a combination of a central processing unit (CPU), a random access memory (RAM), and a read-only memory (ROM) so that arithmetic operations and the like are to be performed with the execution of pieces of software.

In the image forming apparatus 1, the image processing unit 50 processes image data received from a PC or an image reading device, and the processed image data is supplied to the image forming unit 11.

In the image forming unit 11, the photoconductor drum 12 is charged by the charging device 13 while rotating in the direction of arrow A and is then exposed to light emitted from the laser exposure device 14 with reference to the image data received from the image processing unit 50.

Thus, an electrostatic latent image for a black image is formed on the photoconductor drum 12. The electrostatic latent image on the photoconductor drum 12 is then developed by the developing device 15, whereby a black toner image is formed on the photoconductor drum 12.

The image forming apparatus 1 includes a sheet transporting system including a sheet tray 60, which contains sheets P; a pickup roll 61, which is configured to pick up one of the sheets P from the sheet tray 60 with a predetermined timing and transports the sheet P; and transporting rolls 62, which are configured to transport the sheet P that is fed from the pickup roll 61. The sheet transporting system further includes a registration roll 63, which is configured to send the received sheet P to the transfer part T with a predetermined timing.

More specifically, the image forming apparatus 1 includes a detection sensor 51, which is configured to detect the leading end of any sheet P to be supplied to the transfer part T. The detection sensor 51 is located at a position before the transfer part T. When the leading end of a sheet P is detected by the detection sensor 51 at the position before the transfer part T, the sheet P is temporarily stopped. Then, synchronously with the black toner image on the photoconductor drum 12 reaching the transfer part T, the registration roll 63 sends the sheet P to the transfer part T. Then, the black toner image is transferred to the sheet P at the transfer part T where the transfer roll 22 is pressed against the photoconductor drum 12.

In the fixing device 30, the sheet P is nipped by the pressing roll 31 and the fixing roll 32. Specifically, the sheet P is nipped by the pressing roll 31 rotating clockwise and the fixing roll 32 rotating counterclockwise.

Thus, the sheet P is pressed and heated, whereby the toner image on the sheet P is fixed on the sheet P. The sheet P having undergone the above fixing process is then transported by an output roll to a sheet receiving part.

While the transporting belt 21 of the transfer-transporting belt unit 20 is rotating, the transporting belt 21 may be shifted toward and interfere with, for example, any fixed member located near the end of the pressing roll 23. To address such a situation, for example, a tapered part may be provided at each of the two ends of the pressing roll 23 such that the diameter of the tapered part increases toward the center of the pressing roll 23. In such a configuration, end portions of the transporting belt 21 wrap around the respective tapered parts of the pressing roll 23, whereby the shifting of the transporting belt 21 toward the fixed member is suppressed.

However, the tapered parts of the pressing roll 23 may be not enough to suppress the shifting of the transporting belt 21 relative to the pressing roll 23.

In view of the above, the present exemplary embodiment employs an additional member that is rotatable about the axis of the pressing roll 23 and relative to the pressing roll 23, whereby the transporting belt 21, if shifted in the axial direction, is received by the additional member. Details will now be described.

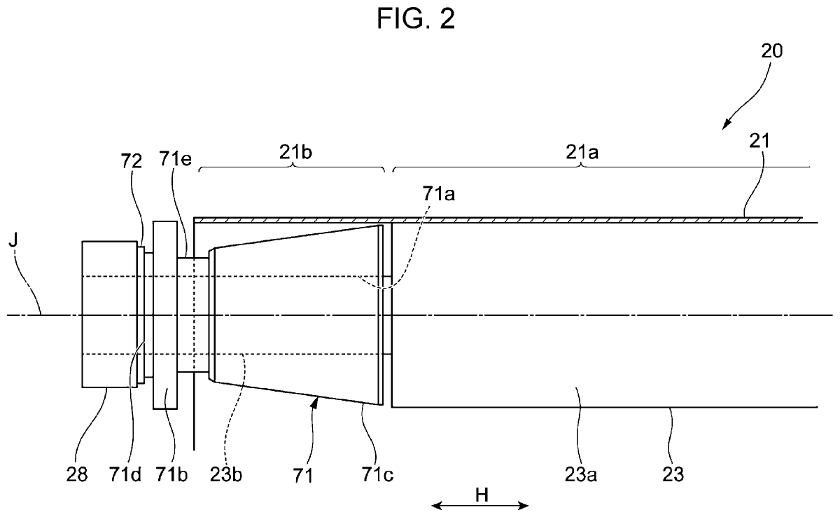

FIG. 2 schematically illustrates relevant elements of the transfer-transporting belt unit 20 according to the present exemplary embodiment, including a configuration of holding the pressing roll 23 over which the transporting belt 21 is stretched. Note that a lower portion of the transporting belt 21 is not illustrated in FIG. 2 for clear illustration of relevant elements including the pressing roll 23 and a pulley 71, which is to be described below. The transporting belt 21 is stretched over two or more rolls.

Referring to FIG. 2, the pressing roll 23 of the transfer-transporting belt unit 20 includes a middle part 23a, which is located in the middle in the axial direction, H; and round-columnar small-diameter end parts 23b, which are located at the respective ends of the pressing roll 23 and each have a smaller diameter than the middle part 23a. The pressing roll 23 is rotatable about an axis J.

The length of the middle part 23a of the pressing roll 23 in the axial direction H is shorter than the width of the transporting belt 21.

The small-diameter end parts 23b of the pressing roll 23 are received by respective recesses provided in fixed holding members 28. The fixed holding members 28 are fixed to a frame (not illustrated) of the image forming apparatus 1 (see FIG. 1). Thus, the pressing roll 23 is rotatably held at the two ends thereof by the two respective fixed holding members 28.

More specifically, the small-diameter end parts 23b of the pressing roll 23 are each provided with a pulley 71 and a washer 72, which are rotatably held. The pulley 71 and the washer 72 are located between the middle part 23a of the pressing roll 23 and a corresponding one of the fixed holding members 28. The pulley 71 held on the small-diameter end part 23b is movable in the axial direction H. The pressing roll 23 is provided at the right and left ends thereof with the pulleys 71: a pair of right and left pulleys 71.

The pulleys 71 are separate from the pressing roll 23 and are each rotatable about the axis J. The pulleys 71 are rotatable relative to the pressing roll 23. The pulleys 71 are each an exemplary rotatable member.

The pulleys 71 each have a hole 71a, which extends through the pulley 71 in the axial direction H and has an inside diameter conforming to the outside diameter of the small-diameter end part 23b of the pressing roll 23. The pulleys 71 each include a receiving part 71b, a tapered part 71c, and a contact part 71d.

The receiving part 71b is located between the tapered part 71c and the contact part 71d and has a flange shape spreading along the entire circumference of the pulley 71 with a greater outside diameter than the contact part 71d. An end face of the receiving part 71b that is nearer to the tapered part 71c serves as a receiving surface that receives an end portion 21b of the transporting belt 21. The receiving surface has no irregularities and is flat.

While the present exemplary embodiment relates to a case where the receiving part 71b has the same outside diameter as the pressing roll 23, the receiving part 71b may have a greater outside diameter than the pressing roll 23 as long as the receiving part 71b is satisfactorily spaced apart from peripheral elements. For example, the outside diameter of the receiving part 71b may be greater than the outside diameter of the pressing roll 23 by the thickness of the transporting belt 21.

The tapered part 71c has an outside diameter that decreases toward the receiving part 71b and forms a linear sloping outer surface. In other words, the tapered part 71c has a sloping surface with the outside diameter thereof being smallest at an end thereof nearer to the receiving part 71b and greatest at the other end thereof nearer to the pressing roll 23.

The pulley 71 is in contact with the transporting belt 21 at the outer surface of the tapered part 71c thereof, and the pulley 71 is therefore rotatable together with the pressing roll 23 by receiving the energy of rotation of the transporting belt 21.

The greatest outside diameter of the tapered part 71c may be either the same as or smaller than the outside diameter of the pressing roll 23.

The tapered part 71c is located nearer to the pressing roll 23 than the receiving part 71b. The tapered part 71c is an exemplary shaped part.

While the present exemplary embodiment relates to the tapered part 71c having a linear sloping surface, the tapered part is not limited thereto and may have a curved sloping surface that is, for example, convex or concave.

The contact part 71d held on the small-diameter end part 23b of the pressing roll 23 faces the washer 72. When the receiving part 71b of the pulley 71 receives the end portion 21b of the transporting belt 21, the contact part 71d is pressed against the washer 72. Accordingly, a frictional force is generated between the contact part 71d and the washer 72 that are pressed against each other, which decelerates the pulley 71 having been rotated at the same speed as the pressing roll 23; that is, the speed of rotation of the pulley 71 becomes lower than the speed of rotation of the pressing roll 23. Note that the contact part 71d of the pulley 71 and the washer 72 are provided for producing a speed difference between the pulley 71 and the pressing roll 23.

The pulley 71 further includes a small-diameter portion 71e, which is located between the receiving part 71b and the tapered part 71c and has an outside diameter smaller than the smallest outside diameter of the tapered part 71c. That is, the tapered part 71c is discontinuous with the receiving part 71b in the axial direction H.

While the pulley 71 according to the present exemplary embodiment includes the tapered part 71c, the pulley 71 is not limited thereto and may include a columnar part having a constant outside diameter, instead of the tapered part 71c having a sloping surface.

The washer 72 is a fixed member, as with the fixed holding member 28, and is a ring-shaped member serving as a fastening member intended for screwing, for example, in the present exemplary embodiment. The washer 72 is made of metal but is not limited thereto and may be made of nonmetal, such as rubber, having a relatively large coefficient of friction. The washer 72 has a flat surface but is not limited thereto and may have an irregular surface so as to increase the coefficient of friction thereof.

While the washer 72 according to the present exemplary embodiment is a fixed member, the washer 72 is not limited thereto and may be a member that is rotatable relative to the fixed holding member 28 but generates a greater resistance to rotation than the pulley 71 so as to generate a frictional force when the pulley 71 comes into contact therewith.

The washer 72 is a member to be pressed by the pulley 71 and is an exemplary extra member and an exemplary fixed member.

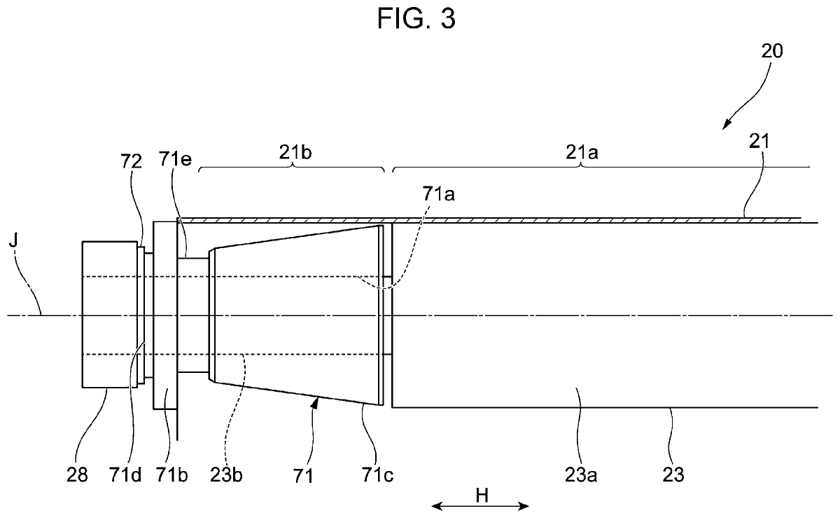

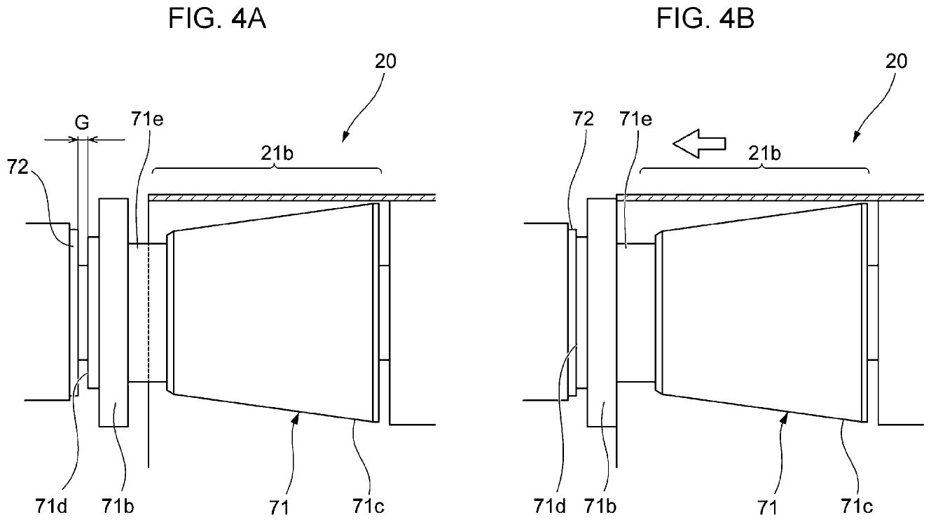

FIG. 3 illustrates a situation where the transporting belt 21 has been shifted in the axial direction H. FIG. 4A illustrates the end portion 21b of the transporting belt 21 to be received by the receiving part 71b of the pulley 71, with the contact part 71d of the pulley 71 being spaced apart from the washer 72; and FIG. 4B illustrates the end portion 21b of the transporting belt 21 to be received by the receiving part 71d of the pulley 71, with the contact part 71d being in contact with the washer 72.

FIGS. 4A and 4B are intended to describe how the pulley 71 pushed in the axial direction H (see FIG. 3) by the transporting belt 21 reacts in the axial direction H, and a gap G illustrated in FIG. 4A therefore has a visually perceivable size. However, the gap G does not necessarily need to have a visually perceivable size as long as the frictional force to be generated between the washer 72 and the pulley 71 pressed thereagainst is to be increased.

Referring to FIG. 3, when the transporting belt 21 is shifted in the axial direction H, the end portion 21b of the transporting belt 21 comes into contact with the end face of the receiving part 71b of the pulley 71. Accordingly, the pulley 71 thus received the transporting belt 21 is pushed toward the washer 72.

More specifically, when the transporting belt 21 is out of contact with the receiving part 71b of the pulley 71, as illustrated in FIG. 4A, the contact part 71d of the pulley 71 is spaced apart from the washer 72 by a slight gap G.

When the transporting belt 21 comes into contact with the receiving part 71b and pushes the receiving part 71b toward the washer 72, the gap G is eliminated as illustrated in FIG. 4B but the pulley 71 that is rotating keeps rotating while being in contact with the washer 72 that is fixed.

In addition, since the pulley 71 includes the tapered part 71c, the end portion 21b of the transporting belt 21 is allowed to bend toward the axis J. Such a configuration allows the receiving part 71b to have a smaller diameter for guiding the transporting belt 21 than in a case where the pulley 71 does not include any tapered part.

Now, a difference in the behavior of the transporting belt 21 between those illustrated in FIGS. 4A and 4B will be described.

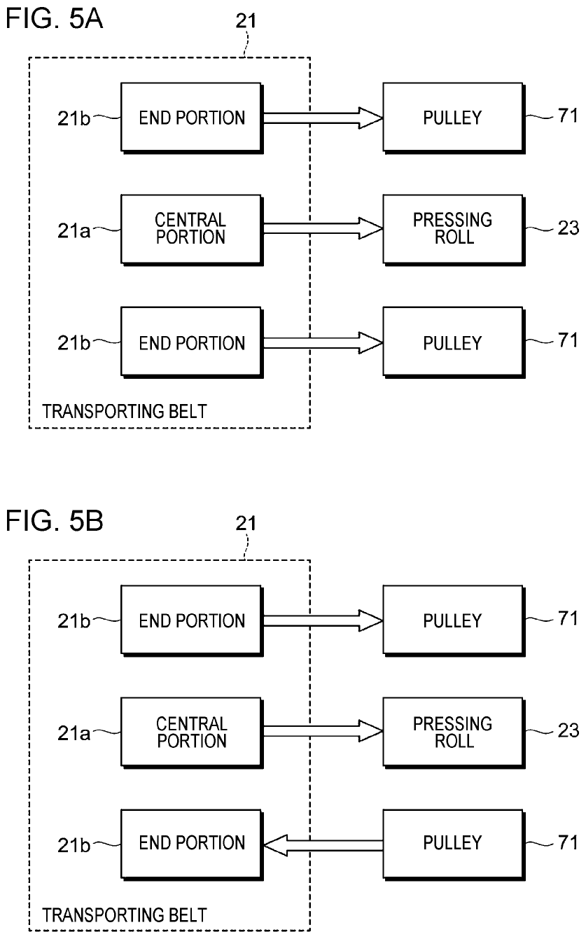

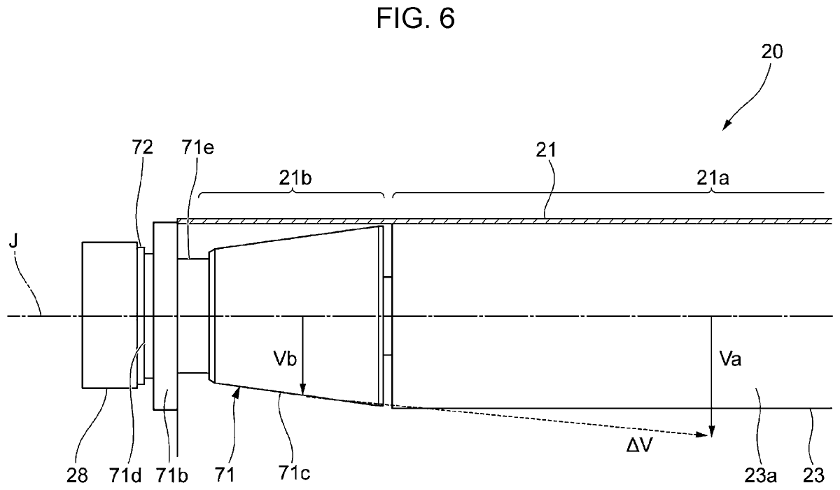

FIGS. 5A and 5B are block diagrams illustrating how the transporting belt 21 and a set of the pressing roll 23 and the pulleys 71 interact with each other, and FIG. 6 illustrates how the transporting belt 21 behaves. In FIGS. 5A and 5B, as a matter of convenience of description, the transporting belt 21 is divided into three portions in the width direction: a central portion 21a and the two end portions 21b. The central portion 21a refers to a region that is in contact with the middle part 23a of the pressing roll 23, and the end portions 21b each refer to a region that is out of contact with the middle part 23a. The central portion 21a is an exemplary first portion, and the end portions 21b are each an exemplary second portion.

When the transporting belt 21 is in contact with neither of the receiving parts 71b of the pair of pulleys 71 (see FIGS. 2 and 4A), the transporting belt 21 that is rotating causes the pressing roll 23 and the pulleys 71 to follow the rotation thereof as illustrated in FIG. 5A. Specifically, the central portion 21a of the transporting belt 21 that is in contact with the pressing roll 23 causes the pressing roll 23 to rotate, and the end portions 21b that are in contact with the respective tapered parts 71c of the pulleys 71 cause the pulleys 71 to rotate. Thus, the central portion 21a and the end portions 21b of the transporting belt 21 act in such a manner as to maintain the speeds of rotation of the pressing roll 23 and the pulleys 71; that is, the pressing roll 23 and the pulleys 71 rotate at the same speed.

When the transporting belt 21 comes into contact with either of the receiving parts 71b of the pair of pulleys 71 (see FIGS. 3 and 4B), the relevant pulley 71 is caused to rotate while being in contact with the washer 72 that is fixed, as described above; that is, the speed of rotation of the pulley 71 that is being pushed by the transporting belt 21 in the axial direction H is reduced. Specifically, as illustrated in FIG. 5B, when the speed of rotation of one of the pulleys 71 is reduced, the speed of rotation of the corresponding end portion 21b of the transporting belt 21 that receives the frictional force from the pulley 71 becomes lower than the speed of rotation of the central portion 21a.

Thus, when the transporting belt 21 comes into contact with the pulley 71, the end portion 21b of the transporting belt 21 is decelerated, which increases the speed difference between the end portion 21b and the central portion 21a.

More specifically, referring to FIG. 6, if the central portion 21a of the transporting belt 21 rotates at a speed Va while the end portion 21b rotates at a speed Vb (Va>Vb), a speed difference ΔV is produced between the speeds Va and Vb, which generates a force that causes the transporting belt 21 to return to the center.

Furthermore, in the present exemplary embodiment, since the pulley 71 includes the tapered part 71c as described above, the end portion 21b of the transporting belt 21 that is decelerated wraps around the tapered part 71c, whereby the amount of shifting of the transporting belt 21 is reduced.

While the present exemplary embodiment relates to a configuration where the pressing roll 23 constantly supports the transporting belt 21, the present disclosure is not limited to such a configuration. The pressing roll 23 may support the transporting belt 21 only in a situation where the transporting belt 21 is shifted in the axial direction H, except the other situation.

While an exemplary embodiment has been described above, any other configuration may be employed. Specifically, while the above exemplary embodiment relates to a configuration in which the pulley 71 is decelerated with the frictional force generated between the pulley 71 that is pushed by the transporting belt 21 and the fixed washer 72 that receives the pulley 71 coming into contact therewith, the present disclosure is not limited to such an embodiment. A modification will now be described.

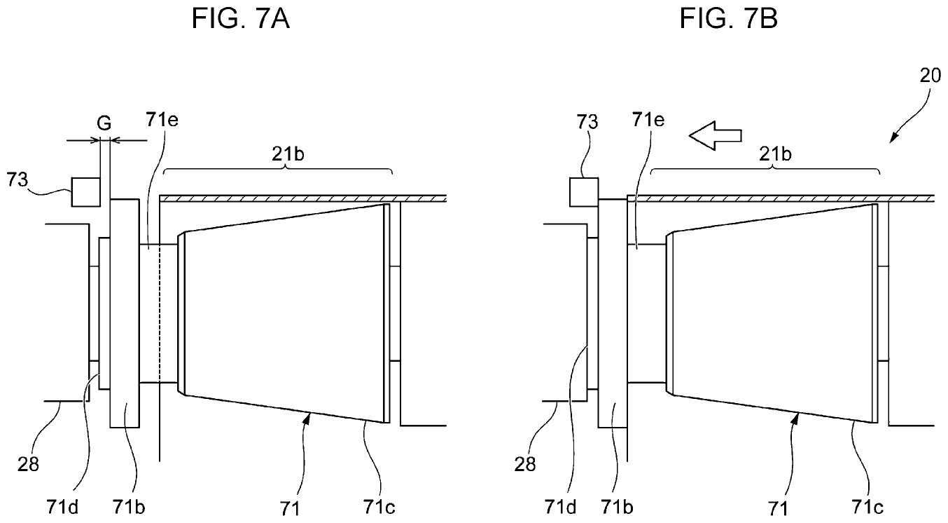

FIG. 7A schematically illustrates relevant elements of a transfer-transporting belt unit 20 according to a modification, with the contact part 71d of the pulley 71 thereof being spaced apart from the fixed holding member 28; and FIG. 7B schematically illustrates the elements with the contact part 71d being in contact with the fixed holding member 28. FIGS. 7A and 7B correspond to FIGS. 4A and 4B illustrating the exemplary embodiment. Basic elements of the modification are common to those employed in the above exemplary embodiment, and some of the elements are neither illustrated nor described.

Referring to FIG. 7A, the transfer-transporting belt unit 20 according to the modification includes no washer 72 (see FIGS. 4A and 4B), unlike the transfer-transporting belt unit 20 according to the above exemplary embodiment. Therefore, the pulley 71 is located next to the fixed holding member 28.

Furthermore, unlike the transfer-transporting belt unit 20 according to the above exemplary embodiment, the transfer-transporting belt unit 20 according to the modification includes a fixed counter member 73, which faces an end face of the receiving part 71b of the pulley 71. The fixed counter member 73 is located across the receiving part 71b from the transporting belt 21. The fixed counter member 73 may be made of either metal or nonmetal such as rubber.

The fixed counter member 73 is an exemplary extra member and an exemplary fixed member.

When the transporting belt 21 is out of contact with the receiving part 71b of the pulley 71, as illustrated in FIG. 7A, the receiving part 71b of the pulley 71 is spaced apart from the fixed counter member 73 by a slight gap G.

When the transporting belt 21 comes into contact with the receiving part 71b of the pulley 71 and pushes the receiving part 71b toward the fixed counter member 73, the gap G is eliminated as illustrated in FIG. 7B but the pulley 71 that is rotating keeps rotating while being in contact with the fixed counter member 73. Thus, the transporting belt 21 behaves substantially the same as in the above exemplary embodiment (see FIG. 6).

While the above exemplary embodiment relates to a transfer scheme in which an image is transferred from the photoconductor drum 12 (see FIG. 1) to a sheet P, the present disclosure may be applied to another transfer scheme in which an image is transferred to a sheet P with the aid of an intermediate transfer body.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A belt unit comprising:
a belt member to be caused to rotate;
a stretching member that is rotatable about an axis and over which the belt member is stretched; and
a rotatable member that is rotatable about the axis and relative to the stretching member and over which the belt member is stretched, the rotatable member including a receiving part configured to receive the belt member in an axial direction when the belt member is shifted in the axial direction.

2. The belt unit according to claim 1, wherein the rotatable member includes a shaped part located nearer to the stretching member than the receiving part and that is tapered toward the receiving part.

3. The belt unit according to claim 2, wherein the shaped part has a tapered shape.

4. The belt unit according to claim 1, wherein when the belt member is received by the receiving part in the axial direction, a speed of rotation of the rotatable member is reduced by being pressed against an extra member in the axial direction and a speed difference is produced in which a speed of rotation of the belt member is lower in a second portion of the belt member than in a first portion of the belt member, the second portion being stretched over the rotatable member, the first portion being stretched over the stretching member.

5. The belt unit according to claim 4, wherein the extra member is a fixed member located across the receiving part from the stretching member.

6. The belt unit according to claim 5, wherein the fixed member is made of nonmetal.

7. The belt unit according to claim 5, wherein the fixed member is made of metal.

8. An image forming apparatus comprising:
an image forming section configured to form an image;
a belt member to be caused to rotate and with an aid of which the image formed by the image forming section is to be transferred to a recording material;
a stretching member that is rotatable about an axis and over which the belt member is stretched; and
a rotatable member that is rotatable about the axis and relative to the stretching member and over which the belt member is stretched, the rotatable member including a receiving part configured to receive the belt member in an axial direction when the belt member is shifted in the axial direction.
